(19) United States
(12) Patent Application Publication
(10) Pub. No.: US 2011/0259989 A1
(43) Pub. Date: Oct. 27, 2011

(54) RECORDING TAPE CARTRIDGE

(75) Inventors: Yasuhiro MORI, Kanagawa (JP); Kenji TAKENOSHITA, Kanagawa (JP)

(73) Assignee: FUJIFILM CORPORATION, Tokyo (JP)

(21) Appl. No.: 13/089,339

(22) Filed: Apr. 19, 2011

(30) Foreign Application Priority Data
Apr. 23, 2010 (JP) 2010-100131
Jan. 24, 2011 (JP) 2011-012206

(51) Int. Cl. G11B 23/04

(52) U.S. Cl. 242/348

(57) ABSTRACT

There is provided a recording tape cartridge including: a reel having a substantially circular tubular hub, on an outer periphery surface of which a recording tape is wound, and flanges provided at two end portions of the hub; a case accommodating the reel; an urging portion that urges the reel toward a floor plate side of the case; a position regulating portion that is formed at an inner surface of a roof plate of the case and that is inserted into the hub; and a protective protruding portion that is formed at the inner surface of the roof plate of the case, wherein the protective protruding portion is formed such that a radial direction outer side end surface thereof is at substantially the same position in the radial direction as the outer periphery surface of the hub.

### CROSS-REFERENCE TO RELATED APPLICATION

This application claims priority under 35 USC 119 from Japanese Patent Applications No. 2010-100131, filed on Apr. 23, 2010, and No. 2011-012206, filed on Jan. 24, 2011, the disclosures of which are both incorporated by reference herein.

### BACKGROUND

1. Technical Field

The present invention relates to a recording tape cartridge that rotatably accommodates a reel on which a recording tape such as a magnetic tape or the like is wound inside a case.

2. Related Art

Heretofore, a recording tape cartridge has been known in which a recording tape such as a magnetic tape or the like, which is principally used as a data recording and replaying medium (data backup) for computers and the like, is wound on a reel fabricated of synthetic resin, and the reel is singly accommodated in a case.

This reel includes a substantially cylindrical hub, on which the recording tape is wound, and an upper flange and an lower flange that are provided at two axial direction end portions of the hub. When the recording tape cartridge is not in use, the reel is put into a rotation-locked state by a braking portion, and is accommodated in the case in a state in which the reel is pressed against a floor plate side of the case by an urging portion such as a coil spring or the like.

Thus, if, for example, a user accidentally drops the recording tape cartridge, the reel may move toward a roof plate side of the case against the above-mentioned urging force because of an impact force acting on the case. If the reel is slanted with respect to the case, an outer periphery edge portion of the upper flange may come into contact with the inner surface of the roof plate of the case and deform to the recording tape side thereof, and damage such as “edge-folding” or the like may occur at width direction end portions of the recording tape.

Accordingly, a reel has been proposed heretofore (for example, see the specification of U.S. Pat. No. 5,734,540) in which a protrusion is provided at the inner surface of the roof plate of the case, and if the reel is slanted with respect to the case by an impact due to being dropped or the like, an upper end portion of the hub comes into contact with this protrusion. Thus, the outer periphery edge portion of the upper flange is unlikely to come into contact with the inner surface of the roof plate of the case.

However, in the reel recited in the specification of U.S. Pat. No. 5,734,540, a position regulating portion that regulates a position of the reel in the radial direction thereof is not provided. Therefore, if the reel is subjected to an impact by being dropped or the like, the upper end portion of the hub may not come into contact with the protrusion as desired. That is, in the reel recited in the specification of U.S. Pat. No. 5,734,540, the possibility of the outer periphery edge portion of the upper flange of the roof coming into contact with the inner surface of the roof plate of the case may not be completely eliminated.

Moreover, in the reel recited in the specification of U.S. Pat. No. 5,734,540, because the position regulating portion that regulates the position of the reel in the radial direction is not provided, if the reel is subjected to an impact by being dropped or the like, the outer periphery edge portions of the upper and lower flanges may come into contact with inner walls that define an accommodating area of the reel. That is, in the reel recited in the specification of U.S. Pat. No. 5,734,540, the outer periphery edge portions of the upper and lower flanges may be deformed to the recording tape sides thereof by coming into contact with the inner walls, and damage may be caused to the width direction end portions of the recording tape.

### SUMMARY

Accordingly, in consideration of the circumstances described above, an object of the present invention is to provide a recording tape cartridge capable of preventing a flange of a reel from coming into contact with inner surfaces of a case even if the case is subjected to an impact.

In order to achieve the object described above, a recording tape cartridge according to a first aspect of the present invention includes: a reel including a substantially circular tubular hub, on an outer periphery surface of which a recording tape is wound, and flanges provided at two end portions of the hub; a case accommodating the reel; an urging portion that urges the reel toward a floor plate side of the case; a position regulating portion that is formed at an inner surface of a roof plate of the case and that is inserted into the hub and regulates a radial direction position of the reel; and a protective protruding portion that is formed at the inner surface of the roof plate of the case, wherein, when the reel slants with respect to the case, one end portion of the hub abuts against the protective protruding portion before the flange abuts against the inner surface of the roof plate so as to prevent the flange from abutting against the inner surface of the roof plate, and wherein the protective protruding portion is formed such that a radial direction outer side end surface thereof is at substantially the same position in the radial direction as the outer periphery surface of the hub.

According to the first aspect of the invention, if an impact is applied to the case by being dropped or the like, the radial direction position of the reel is regulated by the position regulating portion. Therefore, the outer periphery edge portions of the flanges do not come into contact with inner walls that define a reel accommodating area. Furthermore, even if the reel is slanted with respect to the case by the impact, the one end portion of the hub reliably comes into contact with the protective protruding portion. Therefore, outer periphery edge portions of the flanges do not come into contact with the roof plate inner surface of the case. Consequently, problems in which an outer periphery edge portion of a flange deforms to the recording tape side thereof and damages a width direction end portion of the recording tape do not arise.

A recording tape cartridge according to a second aspect of the present invention includes: a reel including a substantially circular tubular hub, on an outer periphery surface of which a recording tape is wound, and flanges provided at two end portions of the hub; a case accommodating the reel; an urging portion that urges the reel toward a floor plate side of the case; a position regulating portion that is formed at an inner surface of a roof plate of the case and that is inserted into the hub and regulates a radial direction position of the reel; and a protective protruding portion that is formed at the inner surface of the roof plate of the case, wherein, when the reel slants with respect to the case, one end portion of the hub abuts against the protective protruding portion before the flange abuts against the inner surface of the roof plate so as to prevent the flange from abutting against the inner surface of the roof plate, and wherein the protective protruding portion is formed such that a radial direction outer side end surface thereof is at a position further to the radial direction inner side relative to the outer periphery surface of the hub.

According to the second aspect of the invention, if an impact is applied to the case by being dropped or the like, the radial direction position of the reel is regulated by the position regulating portion. Therefore, the outer periphery edge portions of the flanges do not come into contact with inner walls that define a reel accommodating area. Furthermore, even if the reel is slanted with respect to the case by the impact, the one end portion of the hub reliably comes into contact with the protective protruding portion. Therefore, outer periphery edge portions of the flange do not come into contact with the roof plate inner face of the case. Consequently, problems in which an outer periphery edge portion of a flange deforms to the recording tape side thereof and damages a width direction end portion of the recording tape do not arise.

A recording tape cartridge according to a third aspect is the recording tape cartridge of the first aspect or the second aspect, in which the protective protruding portion is structured with a plurality of ribs extending in a radial pattern.

According to the third aspect of the invention, whatever radial direction the reel slants in with respect to the case, the one end portion of the hub reliably comes into contact with the protective protruding portion. Therefore, the outer periphery edge portion of the flange may be reliably prevented from coming into contact with the inner surface of the roof plate of the case.

A recording tape cartridge according to a fourth aspect is the recording tape cartridge of any one of the first to third aspects, in which the case is formed with a resin material, and a suppressing portion that suppresses a tilt of the position regulating portion due to resin contraction at a time of molding, is formed at the inner surface of the roof plate of the case, at the radial direction inner side of the position regulating portion.

According to the fourth aspect of the invention, the position regulating portion may be formed accurately. Therefore, the one end portion of the hub may more reliably come into contact with the protective protruding portion, and the outer periphery edge portions of the flanges may be more reliably prevented from coming into contact with the inner surface of the roof plate of the case and the inner walls that define the reel accommodating area.

A recording tape cartridge according to a fifth aspect is the recording tape cartridge of any one of the first to fourth aspects, in which the inner surface of the roof plate of the case at the radial direction outer side relative to the protective protruding portion is formed in a substantial taper shape in cross-section such that a space inside the case widens towards the radial direction outer side.

According to the fifth aspect of the invention, the outer periphery edge portion of the flange may be reliably prevented from coming into contact with the inner surface of the roof plate of the case.

As described above, according to the present invention, a recording tape cartridge may be provided that, even if subjected to an impact, may prevent flanges of a reel from coming into contact with inner surfaces of a case.

### BRIEF DESCRIPTION OF THE DRAWINGS

Exemplary embodiments of the present invention will be described in detail based on the following figures, wherein:

FIG. 1 is a schematic perspective diagram of a recording tape cartridge relating to a first exemplary embodiment;

FIG. 2 is a schematic exploded perspective diagram of the recording tape cartridge relating to the first exemplary embodiment;

FIG. 3 is a schematic bottom view of an upper case of the recording tape cartridge relating to the first exemplary embodiment;

FIG. 4 is a schematic side sectional diagram illustrating a position regulating portion and a protective protruding portion provided at the upper case of the recording tape cartridge relating to the first exemplary embodiment;

FIG. 5 is a schematic side sectional diagram illustrating a portion of the recording tape cartridge relating to the first exemplary embodiment at a time of non-use;

FIG. 6 is a schematic side sectional diagram illustrating the portion of the recording tape cartridge relating to the first exemplary embodiment when subjected to an impact;

FIG. 7 is a schematic side sectional diagram illustrating a portion of a recording tape cartridge relating to a second exemplary embodiment at a time of non-use;

FIG. 8 is a schematic side sectional diagram illustrating the portion of the recording tape cartridge relating to the second exemplary embodiment when subjected to an impact; and

FIG. 9 is a schematic perspective view illustrating an inner surface of an upper case of the recording tape cartridge relating to the second exemplary embodiment.

### DETAILED DESCRIPTION

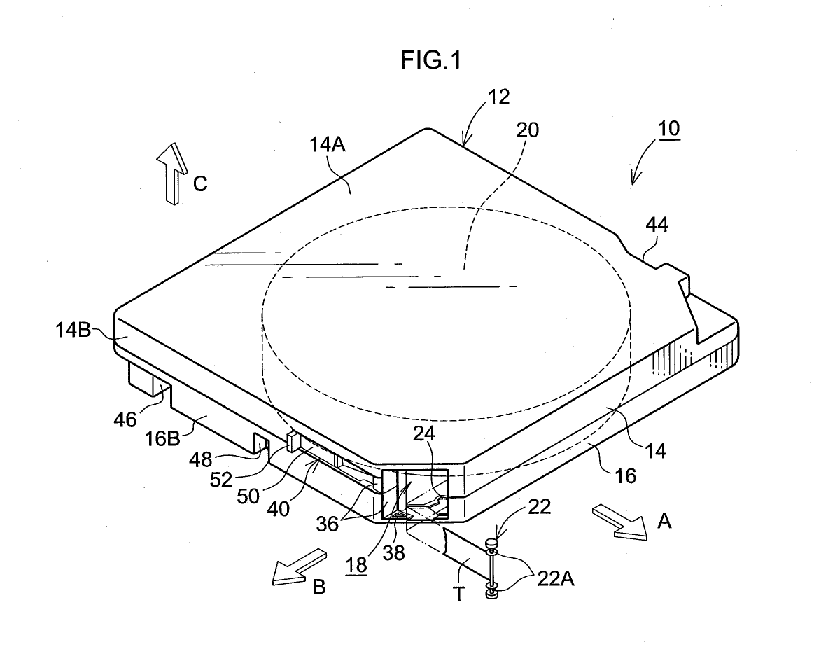

Herebelow, exemplary embodiments of the present invention are described in detail on the basis of examples illustrated in the attached drawings. For convenience of description, a direction of loading of a recording tape cartridge 10 into a drive apparatus (not illustrated) in FIG. 1 is indicated by arrow A, and serves as a forward direction (front side) of the recording tape cartridge 10. The direction of arrow B, which is orthogonal to the direction of arrow A, is a rightward direction (right side), and a direction orthogonal to the directions of arrow A and arrow B is indicated by arrow C and serves as an upward direction (upper side) of the recording tape cartridge 10.

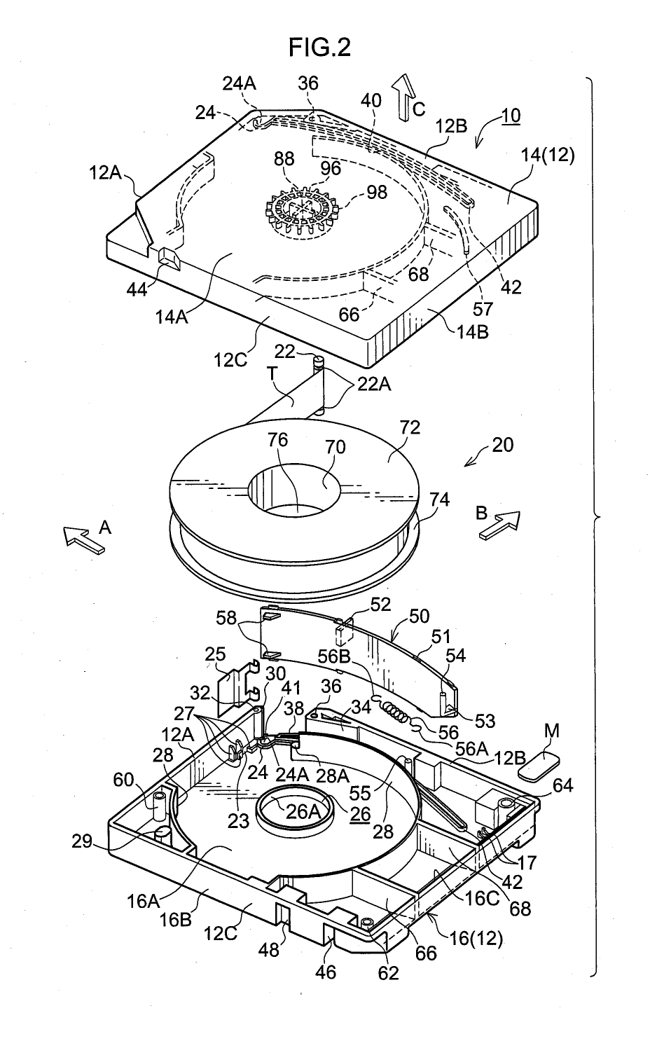

Firstly, the recording tape cartridge 10 relating to a first exemplary embodiment is described. As illustrated in FIG. 1 and FIG. 2, this recording tape cartridge 10 is configured with a single reel 20 rotatably accommodated in a case 12. A recording tape T such as a magnetic tape or the like, which is an information recording and replaying medium, is wound on the reel 20. The case 12 is formed in a substantially rectangular shape in plan view. The reel 20 is described in detail below.

The case 12 is constituted by peripheral walls 14B and 16B of an upper case 14 and a lower case 16, respectively, being matched up and joined. The upper case 14 and the lower case 16 are cut off diagonally in plan view at a front-right corner portion, which is one of the corners at the leading end side of the direction of loading the case into the drive apparatus. Thus, an accommodating space that accommodates the reel 20 is formed inside the case 12.

The cut-off corner portions of the peripheral walls 14B and 16B of the upper case 14 and lower case 16 serve as an aperture 18 for drawing out the recording tape T. A leader pin 22 is attached to a free end of the recording tape T that is to be drawn out through the aperture 18. The leader pin 22 is anchored (engaged) by a drawing portion of the drive apparatus (not illustrated) and operated to be drawn out.

Annular grooves 22A are formed at two end portions of the leader pin 22, which protrude beyond width direction end portions of the recording tape T. The annular grooves 22A are formed such that hooks or the like of the drawing portion may engage therewith. Thus, when the recording tape T is drawn out, the hooks or the like do not touch the recording tape T and do not damage the recording tape T.

A pair of upper and lower pin retention portions 24 are provided inside the case 12, at the inner side of the aperture 18 of the case 12. The pin retention portions 24 position and retain the leader pin 22. The pin retention portions 24 are formed in substantially semi-circular shapes, and retain the two end portions of the leader pin 22, in an upright state, in recess portions 24A. The sides of the pin retention portions 24 through which the recording tape T is drawn out are open, and serve as an entry/exit aperture through which the leader pin 22 enters and leaves.

A plate spring 25 is fixedly disposed in a vicinity of the pin retention portions 24, with a root portion of the plate spring 25 fitting into spring retention portions 27 and groove portions 23 that are provided at inner surfaces of front walls 12A (which are portions of the peripheral walls 14B and 16B whose outer surfaces face in the direction of arrow A). A bifurcated distal end portion of the plate spring 25 engages with each of the upper and lower end portions of the leader pin 22, so as to retain the leader pin 22 in the pin retention portions 24. The distal end portion of the plate spring 25 resiliently deforms as appropriate and allows movement of the leader pin 22 when the leader pin 22 is entering or leaving the pin retention portions 24.

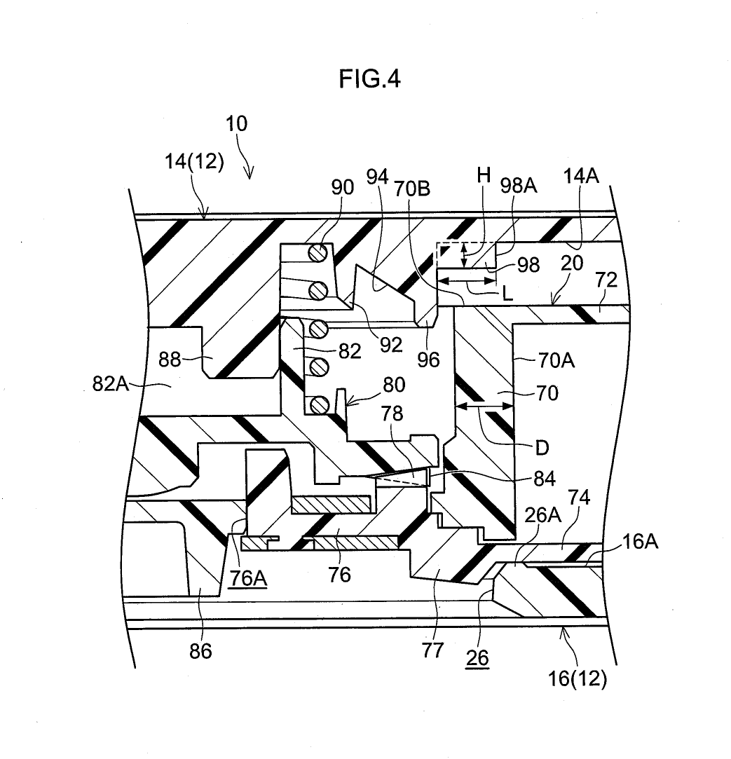

A gear aperture 26 is formed substantially at the middle of the lower case 16, for exposing a reel gear 77 of the reel 20 to the outside (see FIG. 4). The reel gear 77 is meshed with a driving gear of the drive apparatus (not illustrated), and the reel 20 is driven to rotate inside the case 12. An annular rib 26A is provided protruding into the case 12 (upward) at a peripheral edge portion of the gear aperture 26. The annular rib 26A is for positioning of the reel 20 at times of non-use of the recording tape cartridge 10.

The area in which the reel 20 is accommodated is defined by free play-restricting walls 28, which are provided partially protruding from the inner surface of a roof plate 14A of the upper case 14 and the inner surface of a floor plate 16A of the lower case 16, and which serve as inner walls along a circular path (a circumference) that is concentric with the gear aperture 26. The reel 20 is accommodated at the inner side of the free play-restricting walls 28 and retained so as to prevent loose movements.

A pocket portion 28A is provided at the lower case 16 connecting with an end portion of the free play-restricting wall 28 in a vicinity of the aperture 18. A position regulating hole is formed in the pocket portion 28A. At the inside of the front-left corner portion of the lower case 16, a pocket portion 29 is provided at a distance from the free play-restricting wall 28. A position regulating hole, which is a long hole, is formed in the pocket portion 29. The pocket portions 28A and 29 are disposed on a straight line in the direction of arrow B. Surroundings of the position regulating holes at the lower surface side of the case 12 (which are areas that have the same plate thickness as the pocket portions 28A and 29 or are slightly thicker) serve as reference surfaces that implement positioning in a height (up-down) direction with respect to the drive apparatus.

Apart from the end portion that is connected with the pocket portion 28A, the free play-restricting walls 28 of the lower case 16 are connected with the peripheral wall 16B. Thus, the free play-restricting walls 28 divides the accommodating area of the reel 20 (accommodating space) from the outside thereof. The free play-restricting walls 28 of the upper case 14 are similarly (with up-down symmetry) connected with the peripheral wall 14B, and divides the accommodating area of the reel 20 (the accommodating space) from the outside thereof. With this structure, the strength of the case 12 may be improved and the dust resistance of the accommodating area of the reel 20 may be improved.

An outer periphery surface of the free play-restricting wall 28 of the lower case 16 at the rear side of the case 12 is integrally connected with a rear portion inner surface 16C by connecting ribs 66 and 68. The connecting ribs 66 and 68 are formed in flat plate shapes with longitudinal directions in the front-rear direction of the case 12. The connecting rib 66 and the connecting rib 68 are formed to be spaced by a predetermined spacing in the left-right direction (with left-right symmetry). The connecting ribs 66 and 68 are formed in the same manner at the upper case 14 (with up-down symmetry).

A lower screw boss 60 is provided at a predetermined position between the front wall 12A and the free play-restricting wall 28 at the side at which the pocket portion 29 is provided, and forms a pair of a lower screw boss and a lower screw boss at the upper case 14 side. Upper and lower screw bosses 62 and 64 are provided at predetermined positions at corner portions between two left and right end portions of the rear portion inner surface 16C of the lower case 16 and a left wall 12C and a right wall 12B, and form pairs of lower screw bosses and upper screw bosses at the upper case 14 side. These pairs of upper and lower screw bosses 60, 62 and 64 penetrate through the lower case 16 but do not penetrate through the upper case 14.

A pair of upper and lower short angled wall portions 30 are provided at a right end portion of the front wall 12A of the case 12. The angled wall portions 30 define a front edge portion of the aperture 18. The angled wall portions 30 are formed to be inflected along the opening surface of the aperture 18. When the aperture 18 is closed off, a distal end of a door 50 with a substantially circular arc shape in plan view, which is described later, is inserted at the inner side of the angled wall portions 30. Therefore, the angled wall portions 30 form a dust resisting wall such that gaps through which dust and the like may ingress are not formed. A pair of upper and lower screw bosses 32 are provided inside the front wall 12A at a leftward vicinity of the angled wall portions 30.

At the inner side of front end portions of the right walls 12B (which are the portions of the peripheral walls 14B and 16B whose outer surface face in the direction of arrow B) of the case 12, a pair of upper and lower angled wall portions 34 are provided substantially along an outer periphery surface of the below-described door 50 in plan view. Front end surfaces of the angled wall portions 34 define a rear edge portion of the aperture 18, and a pair of upper and lower screw bosses 36 are provided at the front end portions of the angled wall portions 34.

A slit 40 with a predetermined length, which serves as a window portion that communicates between the inside and outside of the case 12, is provided in the right wall 12B of the case 12. The slit 40 is for exposure of an operation protrusion 52 of the below-described door 50. The slit 40 is formed by a front side lower portion of the peripheral wall 14B of the upper case 14 constituting the right wall 12B being cut away, and also opens to the aperture 18 side. Accordingly, when the slit 40 is formed with a portion of the peripheral wall 14B being left at the upper side thereof, stiffness of the case 12 may preferably be maintained.

At the rearward side of the lower case 16, recess portions 48 are formed, at each of which a portion excluding the upper end of the peripheral wall 16B is recessed toward the inside of the case 12 in a substantial H shape in cross-section and is recessed upward from the lower surface of the case 12 (the floor plate 16A is cut away). The recess portions 48 serve as engaging portions at which pulling-in portions (not illustrated) of the drive apparatus engage. Floor surfaces of the recess portions 48 (downward facing surfaces) serve as reference surfaces for positioning in the height (up-down) direction in the drive apparatus.

At the rearward side of the recess portions 48, recess portions 46 are also formed, at each of which a portion excluding the upper end of the peripheral wall 16B is recessed toward the inside of the case 12 in a substantial H shape in cross-section and is recessed upward from the lower surface of the case 12 (the floor plate 16A is cut away). The recess portions 46 serve as engaging portions at which gripping portions (not illustrated) of a library apparatus (not illustrated) engage. The torsional strength of the case 12 (the lower case 16) is improved by the provision of these recess portions 46 and 48.

A recess portion 44 with a trapezoid shape in plan view is formed in an upper surface portion of the left wall 12C of the upper case 14. The recess portion 44 serves as an engaging portion with which a retention portion (not illustrated) provided at the drive apparatus engages, in order to counteract a rotational moment associated with the door 50 moving in the opening direction when the aperture 18 is being opened.

Guide wall portions 42 are provided standing from the upper case 14 and the lower case 16, from a vicinity of the aperture 18 to a vicinity of a region at which the free play-restricting wall 28 is closest to the right wall 12B (hereinafter referred to as the front half) and from a vicinity of a rear end of the slit 40 to a vicinity of the rear wall (hereinafter referred to as the rear half). The guide wall portions 42 stand to a predetermined height (for example, a height of around 1.0 mm to 1.5 mm), to sandwich and support projection portions 51 of the door 50 from both the inner surface side and the outer surface side thereof.

The guide wall portions 42 at the upper case 14 and the lower case 16 have different lengths, with the guide wall portion 42 at the upper case 14 being formed to be longer at the rear half side than the guide wall portion 42 of the lower case 16. This is because a memory board M, which is described below, is disposed at the right wall 12B side of the rear portion inner surface 16C of the lower case 16. A rear end portion of the rear half of each guide wall portion 42 is closed off in a substantially circular arc shape in plan view, and restricts movements of the upper and lower projection portions 51 that are disposed rearmost, such that the door 50 may not move therebeyond.

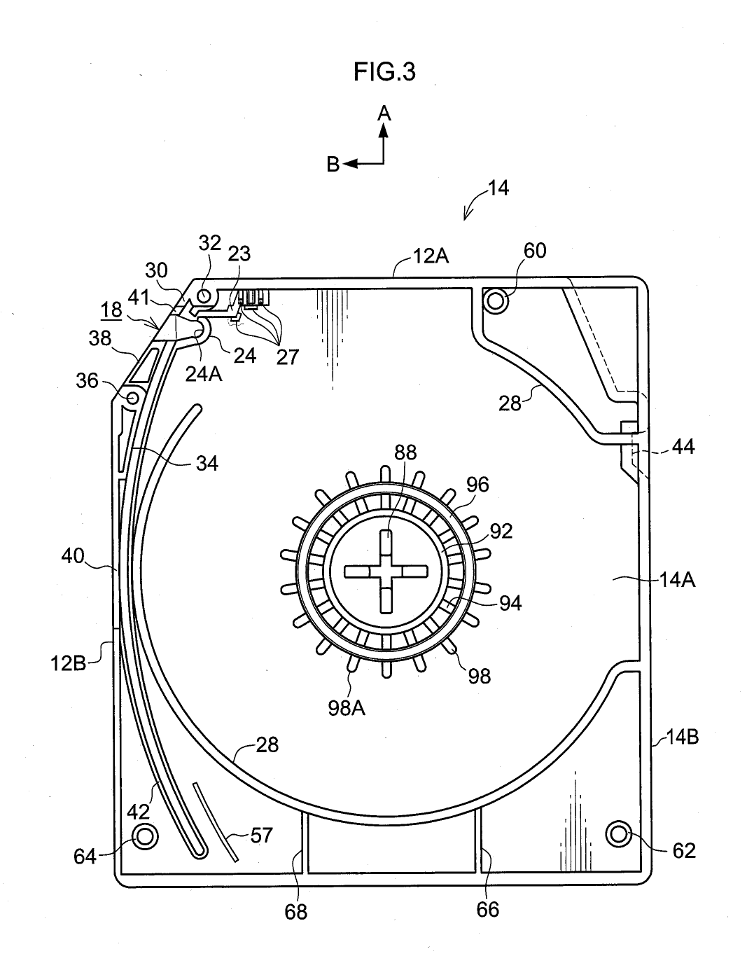

The front halves of the guide wall portions 42, front end portions of which are opened, extend to a position at which entry or exit of the leader pin 22 is not impeded when the leader pin 22 is taken out or put in (i.e., around halfway along the opening width of the aperture 18 at the rearward side of the case 12 relative to the pin retention portions 24, as illustrated in FIG. 3). Guide wall portions 41, rear end portions of which are opened, are provided standing in the vicinity of the angled wall portions 30 so as to be disposed on lines of extension of the guide wall portions 42. Each guide wall portion 41 does not extend to the rearward side relative to the front end of the pin retention portions 24, such that the rear end portion thereof does not impede entry and exit of the leader pin 22. The door 50 closes off the aperture 18 in a state in which the distal end thereof is inserted into the guide wall portions 41.

The guide wall portions 41 and the front halves of the guide wall portions 42 are formed so as to be slightly lower than the rear halves of the guide wall portions 42. For example, heights of the guide wall portions 41 and the front halves of the guide wall portions 42 are formed to around 1 mm, and heights of the rear halves of the guide wall portions 42 are formed to around 1.5 mm. This is in order to assure space for the drawing portion provided at the drive apparatus to enter into the aperture 18. Accordingly, as described below, a plate width (height) of the door 50 at the front half portion thereof (at least the portion that closes off the aperture 18) is formed to be larger (higher) by an amount corresponding to the amount by which the guide wall portions 41 and the front halves of the guide wall portions 42 are lowered.

Reinforcement ribs 38, which are integral with the guide wall portions 42 whose outer sides are exposed through the aperture 18 and which form substantially trapezoid shapes in plan view, are provided standing from the inner surface of the roof plate 14A of the upper case 14 and the inner surface of the floor plate 16A of the lower case 16 to heights equal to the guide wall portions 42. Strengths of the upper case 14 and the lower case 16 in the region of the aperture 18 are assured by the reinforcement ribs 38. The inner sides of the guide wall portions 42 are integrally connected with the pin retention portions 24. Heights of the pin retention portions 24 are substantially equal to heights of the guide wall portions 42 that are integrally connected therewith, but are desirably formed to be slightly higher.

In this configuration, unillustrated screws are screwed into the above-described upper case 14 and lower case 16 from the lower side, into the screw bosses 32 and 36 disposed in the vicinities of the edge portions of the aperture 18 and the screw bosses 60, 62 and 64 mentioned above, and fix (join together) the same. Therefore, in particular, corner portions at the two ends of the aperture 18, which are defined by the free ends of the angled wall portions 30 (the front wall 12A) and the angled wall portions 34 (the right wall 12B) and are prone to impact against a floor or the like due to an accidental drop because of a disadvantage in strength, are firmly joined together. Thus, even if the case 12 is dropped, this structure is not deformed by the whole weight of the recording tape cartridge 10 and does not buckle and displace.

The aperture 18 is opened and closed by the door 50, which serves as a shielding member. The door 50 is formed with the plate width (height) of at least the portion that closes off the aperture 18 being substantially the same as the opening height of the aperture 18, the rear side being slightly smaller (lower), and the plate length being significantly larger than the opening width of the aperture 18. The door 50 is formed in a substantial circular arc shape in plan view that curves in the plate thickness direction, so as to move along a predetermined circumference.

The door 50 closes off the aperture 18 when the distal end portion thereof is inserted into the guide wall portions 41, and opens up the aperture 18 by sliding (turning) substantially rearward along the predetermined circumference mentioned above. When the outer periphery surface of a vicinity of the distal end of the door 50 reaches the vicinity of the screw bosses 36, the aperture 18 is completely open. The door 50 closes off the aperture 18 by sliding (turning) in the opposite direction to that when opening the aperture 18.

Thus, the door 50 is curvedly formed in a circular arc shape corresponding to the predetermined circumference that is the movement track thereof. The center of turning thereof in the present exemplary embodiment is specified to have a position in the left-right direction that is in a vicinity of the left end of the case 12 and a position in the front-rear direction that is in a vicinity of the rear end of the slit 40. Thus, the movement track of the door 50 is closest to the right wall 12B of the case 12 at the vicinity of the rear end of the slit 40. The turning center and radius of the door 50 may be suitably determined in accordance with positions of the front and rear edge portions of the aperture 18 (the angled wall portions 30 and the screw bosses 36), which are determined by the requirements of the drive apparatus, the angle of the opening surface of the aperture 18, which is determined by the requirements of the library apparatus, and so forth.

The curved longitudinal dimension of the door 50 is determined such that the rear end portion thereof is disposed inside the rear-right corner portion to the rearward relative to the recess portion 48 of the case 12 (in the vicinity of the recess portion 46) when the aperture 18 is closed. A lower rear portion of the door 50 is cut away at an angle in order to avoid the memory board M, which is disposed at a predetermined angle θ by position regulating ribs 17, which are described below. At least one of the inner surface and the outer surface of the front end portion of the door 50 is desirably formed to be a tapering surface so as to smoothly enter between the guide wall portions 41.

The projection portions 51 are provided projecting from an upper surface and a lower surface of the door 50. The projection portions 51 slide against guide surfaces of the guide wall portions 42 (inner surfaces thereof that oppose one another), and the inner surface of the roof plate 14A of the upper case 14 and the inner surface of the floor plate 16A of the lower case 16 between the guide wall portions 42, respectively. The projection portions 51 guide the door 50 in the direction of opening and closing the aperture 18.

The projection portions 51 are formed in substantially elliptical shapes in plan view, whose lengths are along the longitudinal direction of the door 50. Four each of the projection portions 51 are projected from the upper surface and the surlower face, so as to be symmetrical between upper and lower apart from the rearmost projection portions 51, and the projection portions 51 have heights substantially the same as the heights of the guide wall portions 42 (for example, about 0.5 mm at the front side relative to a boundary region at which the plate width of the door 50 changes and about 1.5 mm at the rear side thereof). The rearmost projection portions 51 are not symmetrical between upper and lower because of the lower rear portion of the door 50 being cut away at an angle.

Because the projection portions 51 are provided thus, sliding resistance (friction) against the inner surface of the roof plate 14A of the upper case 14 and the inner surface of the floor plate 16A of the lower case 16 between the guide wall portions 41 and the guide wall portions 42 and against the guide surfaces of the guide wall portions 41 and the guide wall portions 42 may be reduced, and the door 50 may be slid smoothly with little resistance. Moreover, because the projection portions 51 are formed in substantially elliptical shapes in plan view, resistance to impacts is more excellent than if they were formed, for example, in substantially circular shapes in plan view. Therefore, even if a force is applied to the door 50 from different directions from the opening and closing direction due to an impact from a fall or the like, there is no danger of the projection portions 51 breaking.

The operation protrusion 52 that serves as an operation portion is projected along the radial direction of the door 50 from the outer periphery surface thereof slightly to forward relative to a longitudinal direction middle portion of the door 50 (at a vicinity of the boundary region at which the plate width of the door 50 changes). The operation protrusion 52 is exposed to outside the case 12 through the slit 40, is disposed slightly apart from the rear end of the screw bosses 36 in the state in which the aperture 18 is closed, and is operable through the portion of the slit 40 that is opened to forward.

In the state in which the aperture 18 is opened, the operation protrusion 52 is disposed slightly apart from the rear end portion of the slit 40. At this time, the rearmost side projection portions 51 abut against the closed off rear end portions of the guide wall portions 42. The slit 40 exposing the operation protrusion 52 communicates between the inside and outside of the case 12. However, because the slit 40 is substantially closed off at all times by the screw bosses 36 and the door 50 that spans substantially the whole height of the interior of the case 12, and because the free play-restricting walls 28 that serve as an inner wall are provided inside the case 12, dust and the like is prevented from adhering to the recording tape T wound on the reel 20.

Stoppers 58 are provided protruding from the inner surface of a front end portion of the door 50. The stoppers 58 abut against an upper end portion side surface and a lower end portion side surface of the leader pin 22 when the aperture 18 is closed. Thus, the stoppers 58 may further prevent the leader pin 22 from being disengaged from the pin retention portions 24 by an impact from a fall or the like.

A coil spring 56 that serves as an urging member, which urges the door 50 in the direction of closing the aperture 18, has a length that reaches the rear-right corner portion of the case 12 in the state in which the door 50 closes off the aperture 18. Thus, the coil spring 56 is disposed to effectively utilize a space in the rear-right corner portion between the free play-restricting walls 28 and the right wall 12B (the peripheral walls 14B and 16B).

That is, a plate-form support portion 53 is integrally connected in the radial direction with the inner periphery surface of the door 50 at a rear end vicinity thereof, and a spring support portion 54 is integrally provided to protrude upward from an upper surface of the support portion 53. A circular rod-shaped spring anchoring portion 55 is provided protruding upward from the inner surface of the lower case 16 in a vicinity of the recess portion 48. Ring-shaped attachment portions 56A and 56B are formed at the two ends of the coil spring 56. Therefore, the coil spring 56 may be simply mounted in the above-mentioned space by the one attachment portion 56B being fitted round the spring anchoring portion 55 from thereabove and the other attachment portion 56A being fitted round the spring support portion 54 from thereabove.

A guide rib 57 is provided standing, in a substantial circular arc shape in plan view, from the inner surface of the roof plate 14A of the upper case 14. The upper end of the spring support portion 54 slides against the guide rib 57 when the door 50 is opening and closing. This guide rib 57 is provided with a position and length such that the upper end of the spring support portion 54 may slide thereagainst at least when the door 50 starts to move (open), and guides the spring support portion 54 to move against the urging force of the coil spring 56. Thus, the door 50 is more stably opened (without the door 50 being wobbled by the urging force of the coil spring 56).

Because the guide rib 57 is provided, the attachment portion 56A of the coil spring 56 that is mounted as described above may be prevented from disengaging from the spring support portion 54 even if an impact due to a fall or the like is applied to the case 12 and the attachment portion 56A rises up along the spring support portion 54. At the spring anchoring portion 55 too, because the upper end of the spring anchoring portion 55 is inserted between the free play-restricting wall 28 and the guide wall portion 42 of the upper case 14, the attachment portion 56B may be similarly prevented from disengaging from the spring anchoring portion 55.

The memory board M is disposed at the rear-right portion of the lower case 16. The memory board M stores various kinds of information such as recording volumes, recording formats and the like, may be contactlessly accessed by an unillustrated reading and writing device, and is angled at a predetermined angle θ (for example, θ=45°). Specifically, the rear portion inner surface 16C of the lower case 16 is inclined at a predetermined angle, and the position regulating ribs 17 are plurally provided (for example, two) protruding from the inner surface of the floor plate 16A of the lower case 16 at the forward side in the case 12 relative to the rear portion inner surface 16C but at the rearward side in the case 12 relative to the free play-restricting walls 28. The position regulation ribs 17 are spaced apart by a predetermined spacing in the left-right direction.

Thus, the memory board M is disposed at the rear portion inner surface 16C and is retained in an attitude that is inclined at the predetermined angle θ by lower end portion of the memory board M being supported (so as not to slip down) by the position regulating ribs 17. The inclination angle θ of the rear portion inner surface 16C is desirably set to 45° in order to enable access to the memory board M from both the lower surface side and the rear surface side of the case 12.

Next, the reel 20 and the braking portion are described. As illustrated in FIG. 2 and FIG. 4, the reel 20 includes a substantially circular tubular hub 70, an upper flange 72 and a lower flange 74. The upper flange 72 is integrally provided extending outward in the radial direction from an upper end portion (one end portion in the axial direction) of the hub 70. The lower flange 74 is provided with a floor wall 76 that closes off a lower end portion (the other end portion in the axial direction) of the hub 70. The reel 20 is assembled by the floor wall 76 of the lower flange 74 being welded to the lower end portion of the hub 70.

As illustrated in FIG. 4, a brake member 80 that serves as the braking portion is provided inside the hub 70 of the reel 20. This brake member 80 is formed in a substantially circular plate shape. A braking wall portion 82 that includes a groove portion 82A with a cross shape in plan view is provided protruding from the upper surface of the brake member 80. A braking gear 84 is formed in an annular shape at the lower surface of the brake member 80, and is meshable with an engaging gear 78 that is formed in an annular shape at the upper surface of the floor wall 76 of the reel 20.

As illustrated in FIG. 2 to FIG. 4, an annular rib 92 is provided protruding inward (downward) in the case 12 from the inner surface of the roof plate 14A of the upper case 14, at a position opposing the gear aperture 26 (the annular rib 26A). A braking rib 88 with a cross shape in bottom view is provided protruding inward (downward) in the case 12 at the radial direction inner side of the annular rib 92. The braking rib 88 fits into the groove portion 82A of the braking wall portion 82. Thus, this structure disables rotation of the brake member 80.

As also illustrated in FIG. 4, a coil spring 90 is provided inside the case 12. The coil spring 90 serves as an urging portion that urges the reel 20 downward (toward the floor plate 16A of the lower case 16) via the brake member 80. One end portion (the upper end portion) of the coil spring 90 is disposed at the radial direction outer side of the braking rib 88, at the radial direction inner side of the annular rib 92, and the other end portion (the lower end portion) is disposed at the radial direction outer side of the braking wall portion 82 of the brake member 80.

The braking gear 84 of the brake member 80 that is made non-rotatable is meshed with the engaging gear 78 by the urging force of the coil spring 90, preventing unwanted rotation of the reel 20 when the recording tape cartridge 10 is not in use (when not loaded in the drive apparatus).

When the recording tape cartridge 10 is used, a release member 86 that is provided for fall protection in a penetration hole formed in the middle of the floor wall 76 is lifted upward by a release protrusion (not illustrated) of the drive apparatus. Accordingly, the brake member 80 is lifted up against the urging force of the coil spring 90 via the release member 86, and the meshing between the braking gear 84 and the engaging gear 78 is disengaged. Thus, this structure enables rotation of the reel 20 in the case 12.

As also illustrated in FIG. 2 to FIG. 4, support ribs 94 are plurally formed at the inner surface of the roof plate 14A of the upper case 14, at the radial direction outer side of the annular rib 92. The support ribs 94 are elongated plate-shaped suppressing portions that extend to the radial direction outer side away from the middle side of the reel 20. That is, the support ribs 94 are arranged with uniform spaces in a radial pattern concentric with the annular rib 92 (the reel 20). In the illustrated case, eighteen of the annular ribs 92 are spaced with central angles of 20°.

More specifically, base ends (radial direction inner side end surfaces) of the support ribs 94 are formed integrally with an outer periphery surface of the annular rib 92, and terminal ends thereof (radial direction outer side end surfaces) are formed integrally with an inner periphery surface of a position regulating rib 96, which is described below. Heights of the support ribs 94 are inclined so as to be progressively higher from the radial direction inner side to the outer side. Thus, when the position regulating rib 96, which is formed in an annular shape, is molded, tilting thereof to the radial direction inner side due to resin contraction (caused by differences in plate thickness) is suppressed by the support ribs 94 so as not to occur.

As illustrated in FIG. 4, the position regulating rib 96, which serves as a position regulating portion, is protruded to a height such that insertion of the position regulating rib 96 into the hub 70 may be maintained so as to regulate a radial direction position of the reel 20 accommodated in the case 12 (so as to center the reel 20) when the recording tape cartridge 10 is not in use. That is, an outer diameter of the position regulating rib 96 is made slightly smaller than an inner diameter of the hub 70, such that the position regulating rib 96 is inserted into the reel 20 in a state of being close to the inner periphery surface of the hub 70.

Protection ribs 98 that serve as a protective protruding portion are plurally formed at the radial direction outer side of the position regulating rib 96. The protection ribs 98 are elongated flat plate shapes that extend to the radial direction outer side away from the middle side of the reel 20. That is, the protection ribs 98 are arranged with uniform spaces therebetween in a radial pattern concentric with the position regulating rib 96 (the reel 20). The spaces and the number thereof are determined such that an upper end portion 70B, which is the one end portion of the hub 70, abuts against the protection ribs 98 no matter which radial direction the reel 20 slants in with respect to the case 12. In the illustrated case, the protection ribs 98 are formed on lines of extension of the support ribs 94. That is, the protection ribs 98 are formed with the same space and the same number as the support ribs 94.

As illustrated in FIG. 4, radial direction inner side end surfaces of the protection ribs 98 are formed integrally with the outer periphery surface of the position regulating rib 96, and positions of radial direction outer side end surfaces 98A of the protection ribs 98 are disposed at substantially the same position in the radial direction as an outer periphery surface 70A of the hub 70, or a position further to the radial direction inner side than the outer periphery surface 70A of the hub 70 (for example, within a range of the thickness of the hub 70). That is, because the position regulating rib 96 is disposed close to the inner periphery surface of the hub 70, a length L in the radial direction of the protection ribs 98 is substantially the same as a plate thickness D of the hub 70 (L≈D) or is not more than the plate thickness D (L≦D).

A height H of the protection ribs 98 is constant in the radial direction, being formed to a predetermined height that is lower than the height of the position regulating rib 96 such that, when the recording tape cartridge 10 is being used (when the reel 20 is supported to a raised position against the urging force of the coil spring 90), the upper end portion 70B of the hub 70 does not come into contact with the protection ribs 98 but if the reel 20 slants with respect to the case 12, the upper end portion 70B of the hub 70 comes into contact with (abuts against) the protection ribs 98 before an outer periphery edge portion 72A of the upper flange 72 comes into contact with the inner surface of the roof plate 14A of the upper case 14.

The recording tape cartridge 10 with the configuration described above operates as described next. When the recording tape cartridge 10 with the configuration described above is not in use (when not loaded in the drive apparatus but being stored, transported or the like), the aperture 18 is closed off by the door 50. Specifically, the door 50 is urged in the direction of closing off the aperture 18 by the urging force of the coil spring 56 and closes off the aperture 18 in a state in which the distal end portion (front end portion) of the door 50 is inserted into the guide wall portions 41 in the vicinity of the angled wall portions 30.

The reel 20 is urged toward the floor plate 16A of the lower case 16 by the urging force of the coil spring 90, via the brake member 80. That is, the braking gear 84 formed at the lower surface of the brake member 80 is meshed with the engaging gear 78 formed at the upper surface of the floor wall 76 of the reel 20 by the urging force of the coil spring 90, and rotation of the brake member 80 is disabled by the braking rib 88 that protrudes from the inner surface of the roof plate 14A of the upper case 14 being inserted into the groove portion 82A of the braking wall portion 82 formed at the upper surface of the brake member 80. Thus, unwanted rotation of the reel 20 is prevented.

In this state, the recording tape cartridges 10 are plurally stored in the library apparatus. A reading and writing device provided at an unillustrated robot hand accesses the memory board M from the rear surface (rear wall) side of the respective recording tape cartridge 10, reads the various kinds of information such as recording volume and the like stored therein, and transmits this information to a control device (not illustrated). Hence, an optimum drive apparatus for the respective recording tape cartridge 10 (that is capable of reading and writing the recording tape cartridge 10) is identified in advance by the control device.

When the recording tape T is to be used, one of the recording tape cartridges 10 is taken out from the library apparatus by the robot hand, and this recording tape cartridge 10 is loaded into the drive apparatus in the direction of arrow A. This drive apparatus is selected based on a result of reading the information stored in the memory board M, and the recording tape cartridge 10 is loaded into this drive apparatus by the robot hand smoothly and efficiently. In association with this loading, an opening and closing member of the drive apparatus (not illustrated) advances into the slit 40 that is opened forward and engages with the operation protrusion 52 of the door 50.

In this state, when the recording tape cartridge 10 (the case 12) is pushed further in the direction of arrow A, because of the force of this pushing, the opening and closing member moves the operation protrusion 52 rearward (i.e., relatively moves the operation protrusion 52 rearward with respect to the case 12 that is being loaded in the direction of arrow A) against the urging force of the coil spring 56. Accordingly, the door 50, from which the operation protrusion 52 is protruded, turns in a clockwise direction in plan view along the direction of the curve thereof, with the projection portions 51 of the door 50 being guided by the guide wall portions 42.

That is, the door 50 moves substantially rearward so as to turn around the outer side of the pin retention portions 24 and the reel 20 without running off the movement path along the shape of the curve thereof, and opens the aperture 18. Then, when the case 12 (the recording tape cartridge 10) has been loaded to a predetermined depth into the drive apparatus, the aperture 18 is fully opened and is positioned. A reading and writing device provided in the drive apparatus accesses the memory board M from the lower surface side of the recording tape cartridge 10, reads the various kinds of information stored therein, and writes particular information as required.

In the state in which the aperture 18 is opened thus, when the recording tape cartridge 10 is positioned in the drive apparatus, further rotation of the door 50 (movement substantially rearward) is restricted. A drawing portion of the drive apparatus advances into the case 12 through the aperture 18, takes out the leader pin 22 that is positioned and retained at the pin retention portions 24, and accommodates the leader pin 22 into an unillustrated winding reel.

Meanwhile, a rotary shaft (not illustrated) of the drive apparatus enters through the gear aperture 26, and a release protrusion provided at this rotary shaft pushes the release member 86 relatively upward. That is, the brake member 80 is pushed upward against the urging force of the coil spring 90 via the release member 86, and the meshing of the braking gear 84 with the engaging gear 78 is released. Then, a driving gear provided at the rotary shaft meshes with the reel gear 77 of the reel 20. Thus, the reel 20 is made rotatable in association with the operation of taking out the leader pin 22.

When the leader pin 22 is accommodated in the winding reel, the winding reel and the reel 20 are driven to rotate in synchrony. Thus, the recording tape T is wound onto the winding reel and is drawn out from the case 12 sequentially. Information is read and written by a recording and replaying head (not illustrated) disposed on a predetermined tape path. When this recording and replaying of information is completed, the recording tape T is wound back onto the reel 20 by the winding reel and the reel 20 being rotated in the opposite direction, and the leader pin 22 is positioned and retained at the pin retention portions 24.

Then, when the recording tape cartridge 10 is being ejected from the drive apparatus, the rotary shaft relatively moves out through the gear aperture 26. Accordingly, the brake member 80 is moved downward (toward the floor plate 16A of the lower case 16) by the urging force of the coil spring 90, and the braking gear 84 meshes with the engaging gear 78. Then, the release member 86 protrudes downward through a penetration hole 76A and the state of positioning of the recording tape cartridge 10 with respect to the drive apparatus is released.

Thereafter, the recording tape cartridge 10 is moved in the opposite direction to the direction of arrow A by the urging force of the coil spring 56 and/or an unillustrated ejection mechanism. Accordingly, the door 50 turns back in the direction of closing the aperture 18 by the urging force of the coil spring 56 with the projection portions 51 of the door 50 being guided by the guide wall portions 42. The distal end portion of the door 50 enters into the guide wall portions 41, and thus the aperture 18 is completely closed off, returning to the initial state.

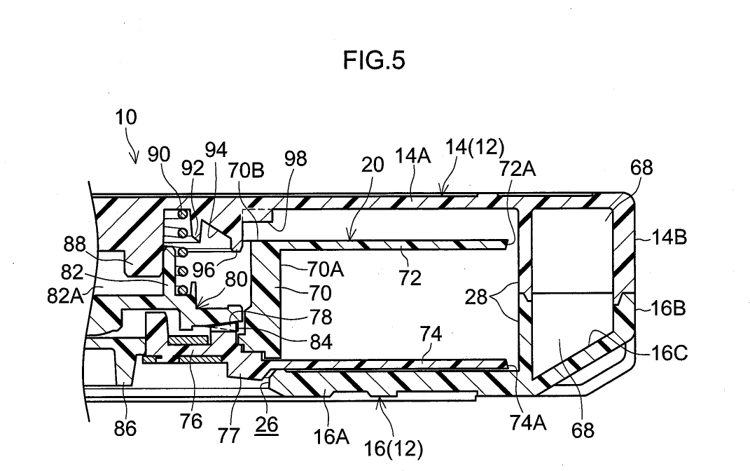

Here, even if the recording tape cartridge 10 is dropped or the like and an impact is applied to the case 12, since the position regulating rib 96 is inserted into the hub 70 in a state of being close to the inner periphery surface of the hub 70 of the reel 20, as illustrated in FIG. 5, the radial direction position of the reel 20 is regulated to the predetermined position (the reel 20 is centered), and there is no risk of the respective outer periphery edge portions 72A and 74A of the upper flange 72 and the lower flange 74 coming into contact with the free play-restricting walls 28.

Therefore, a defect in which the outer periphery edge portions 72A and 74A of the upper flange 72 and lower flange 74, which are easily deformed due to being distant from the outer periphery surface 70A of the hub 70, come into contact with the free play-restricting walls 28 and bend towards the recording tape T, and cause width direction end portions (edges) of the recording tape T to be damaged, does not occur.

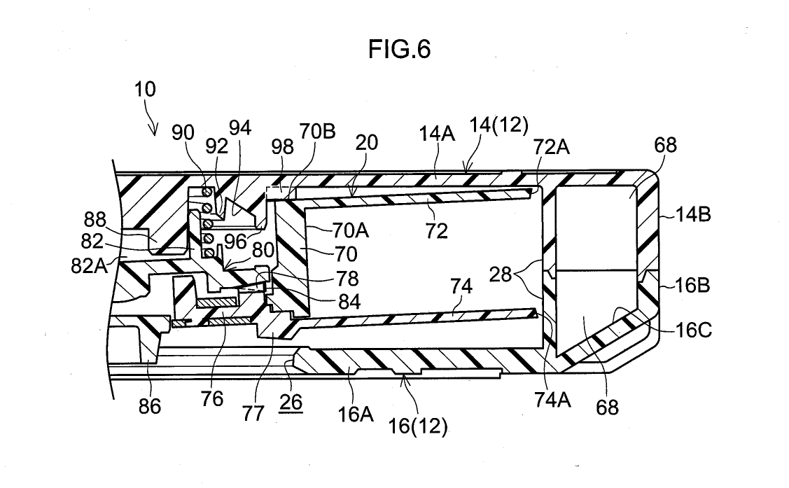

Even if an impact is applied to the case 12 and the reel 20 slants in the up-down direction with respect to the case 12 as illustrated in FIG. 6, before the easily deformed outer periphery edge portion 72A of the upper flange 72 comes into contact with the inner surface of the roof plate 14A of the upper case 14, the upper end portion 70B of the hub 70, which has high stiffness and no risk of deformation, comes into contact with the protection ribs 98. Therefore, the outer periphery edge portion 72A of the upper flange 72 does not come into contact with the inner surface of the roof plate 14A of the upper case 14.

That is, the reel 20 is urged downward (toward the floor plate 16A of the lower case 16) by the coil spring 90, and a gap (a clearance) is formed between the upper surface of the upper flange 72 and the inner surface of the roof plate 14A of the upper case 14. Therefore, when an impact is applied to the case 12 by a fall or the like, the reel 20 easily slants in the up-down direction with respect to the case 12.

However, because the protection ribs 98 with the shape and length L as described above are provided at predetermined positions of the inner surface of the roof plate 14A of the upper case 14, when the reel 20 slants in the up-down direction, the upper end portion 70B of the hub 70 reliably comes into contact with the protection ribs 98. Therefore, the outer periphery edge portion 72A of the upper flange 72 does not come into contact with the inner surface of the roof plate 14A of the upper case 14 and bend toward the recording tape T (narrowing the gap between the upper flange 72 and the lower flange 74), and the width direction end portions (edges) of the recording tape T are not damaged.

The length L of the protection ribs 98 is defined as described above. This is because, if the radial direction length L of the protection ribs 98 were longer than the plate thickness D of the hub 70 (L>D), the upper surface of the upper flange 72 might come into contact with the protection ribs 98 at the radial direction outer side relative to the outer periphery surface 70A of the hub 70 and the upper flange 72 might be deformed toward the recording tape T by the protection ribs 98. Thus, damage to the width direction end portions (edges) of the recording tape T may be reliably prevented by defining the length of the protection ribs 98 as described above.

In addition, because the protection ribs 98 respectively extend away from the middle side of the reel 20 in a radial pattern and the angles formed between adjacent protection ribs 98 are equal, no matter which radial direction (over the whole circumference of the upper flange 72) the reel 20 slants in the up-down direction in, damage to the width direction end portions (edges) of the recording tape T is reliably prevented.

Furthermore, because the protection ribs 98 are formed in the radial pattern, compared with formation in an annular pattern like the position regulating rib 96, a plate thickness difference may be reduced. Therefore, there is an advantage in that tilting due to resin contraction during molding may be made less likely to occur. Thus, the protection ribs 98 may be formed more accurately.

Next, a recording tape cartridge 11 relating to a second exemplary embodiment is described. Portions that are the same as in the recording tape cartridge 10 relating to the first exemplary embodiment are assigned the same reference numerals and are not described in detail. Operations of the recording tape cartridge 11 relating to the second exemplary embodiment are the same as operations of the recording tape cartridge 10 relating to the first exemplary embodiment, so are not described.

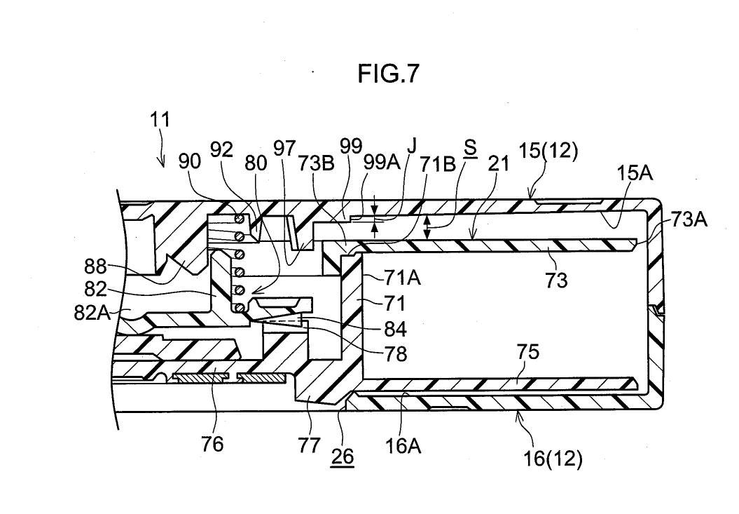

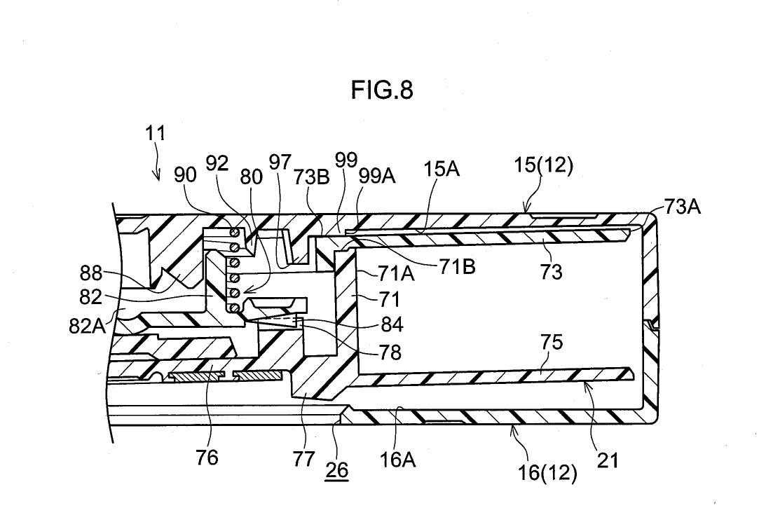

As illustrated in FIG. 7 and FIG. 8, a reel 21 that is accommodated in the recording tape cartridge 11 relating to the second exemplary embodiment has a configuration in which a lower flange 75 and a hub 71 are integrally formed, and a lower surface of an inner periphery edge portion 73B of an upper flange 73 is assembled to an upper end portion 71B of the hub 71 by welding.

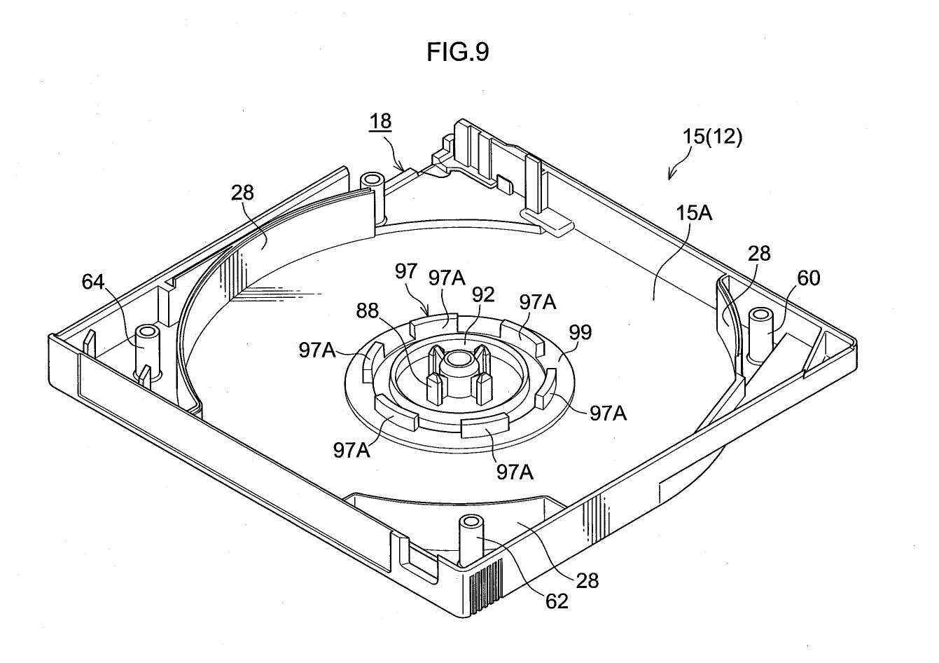

As illustrated in detail in FIG. 9, in order from the radial direction inner side, a position regulating rib 97 that serves as the position regulating portion similarly to the position regulating rib 96 and an annular protective protruding portion 99 that serves as the protective protruding portion similarly to the protection ribs 98 are formed at the inner surface of a roof plate 15A of an upper case 15 of the recording tape cartridge 11.

The position regulating rib 97 illustrated in FIG. 9 has a configuration in which a plural number (for example, six) of small ribs 97A, with substantial circular arc shapes in bottom view, are provided projecting non-continuously (at equal intervals). However, similarly to the position regulating rib 96, the position regulating rib 97 may be formed in a continuous annular shape. Conversely, the position regulating rib 96 may have a structure in which, similarly to the position regulating rib 97, plural small ribs with substantial circular arc shapes in bottom view (not illustrated) are provided projecting non-continuously (at equal intervals).

Moreover, the protective protruding portion 99 illustrated in FIG. 9 is formed in an annular shape but, similarly to the protection ribs 98, may be constituted by ribs in a radial pattern. Conversely, the recording tape cartridge 10 relating to the first exemplary embodiment may have a configuration in which, in place of the protection ribs 98, a protective protruding portion (not illustrated) in an annular shape similar to the protective protruding portion 99 is formed to the same height as the protection ribs 98.

As illustrated in FIG. 7, similarly to the first exemplary embodiment, the position of a radial direction outer side end surface 99A of the protective protruding portion 99 is set to a position that is at the same position in the radial direction as an outer periphery surface 71A of the hub 71, or a position further to the radial direction inner side than the outer periphery surface 71A. A height J of the protective protruding portion 99 is constant in the radial direction.

The recording tape cartridge 11 relating to the second exemplary embodiment has a configuration in which a gap between the upper flange 73 of the reel 21 and the inner surface of the roof plate 15A of the upper case 15, that is, a clearance S in the up-down direction, is smaller than in the recording tape cartridge 10 relating to the first exemplary embodiment, when the recording tape cartridge 11 is not in use.

Therefore, when the recording tape cartridge 11 is loaded into a drive apparatus and used, inside the case 12, the upper flange 73 is disposed close to the inner surface of the roof plate 15A of the upper case 15. Accordingly, the height J of the protective protruding portion 99 is set lower than the height H of the protection ribs 98 (J<H) such that the inner periphery edge portion 73B of the upper flange 73 does not come into contact with the protective protruding portion 99 at times of use.

In this recording tape cartridge 11, as illustrated in FIG. 7, the inner surface of the roof plate 15A of the upper case 15 at the radial direction outer side relative to the protective protruding portion 99 is formed in a substantial taper shape in sectional view, such that the space inside the case 12 progressively widens toward the radial direction outer side.

Therefore, as illustrated in FIG. 8, if the reel 21 slants in the up-down direction by an impact due to a fall or the like, the inner periphery edge portion 73B of the upper flange 73 that is disposed directly above the upper end portion 71B of the hub 71 may come into contact with the protective protruding portion 99 before an outer periphery edge portion 73A of the upper flange 73 comes into contact with the inner surface of the roof plate 15A of the upper case 15.

That is, hereby, even if the reel 21 slants in the up-down direction by an impact due to a fall or the like, the outer periphery edge portion 73A of the upper flange 73 of the reel 21 may be prevented from coming into contact with the inner surface of the roof plate 15A of the upper case 15.

Thus, with the recording tape cartridge 11 relating to the second exemplary embodiment too, which is configured with the aforementioned clearance S being smaller than in the recording tape cartridge 10 relating to the first exemplary embodiment, the same operational effects as in the recording tape cartridge 10 relating to the first exemplary embodiment may be obtained by forming the inner surface of the roof plate 15A of the upper case 15 in the form described above.

Hereabove, the recording tape cartridge 10 relating to the present exemplary embodiments is described on the basis of the examples illustrated in the drawings, but the recording tape cartridge 10 relating to the present exemplary embodiments is not to be limited to the illustrated examples, and the design thereof may be suitably modified within a technical scope that does not depart from the spirit of the present invention.

For example, the protective protruding portion relating to the present exemplary embodiments is not to be limited to rib shapes extending in a radial pattern from the position regulating rib 96, as with the protection ribs 98 illustrated in FIG. 3. For example, configurations are possible with a rib shape that extends in a spiral pattern from the position regulating rib 96, plural hemispherical protrusions arrayed in an annular pattern with equal spaces at the radial direction outer side of the position regulating rib 96, or the like.

However, if the protective protruding portion is formed in an annular shape with a height greater than or equal to a certain height, there is a risk that tilting due to resin contraction as mentioned above may occur. Therefore, if the protective protruding portion is formed to be higher than the protective protruding portion 99, it is desirable that the protective protruding portion not be formed in an annular shape.

It is sufficient that the position regulating ribs 96 and 97 have shapes that are capable of centering the reel 20, and the illustrated ribs are not to be limiting. However, it is desired that the position regulating portion is not formed in an annular shape as with the position regulating rib 97 since occurrences of tilting due to resin contraction as mentioned above may be suppressed.

The door 50 is formed in a substantial circular arc shape in plan view, and slides along a predetermined circumference, but this is not to be limiting. For example, a flat plate-shaped door that slides along a predetermined straight line is also possible. The present invention may be similarly applied to a so-called two-reel recording tape cassette that rotatably accommodates two reels in a case.

It is sufficient that the recording tape T be understood as being an information recording and replaying medium with an elongated tape form that is capable of recording information and replaying recorded information. Obviously, the recording tape cartridge 10 is applicable to a recording tape T of any recording/replaying type.

What is claimed is:

1. A recording tape cartridge comprising:
a reel including a substantially circular tubular hub, on an outer periphery surface of which a recording tape is wound, and flanges provided at two end portions of the hub;
a case accommodating the reel;
an urging portion that urges the reel toward a floor plate side of the case;
a position regulating portion that is formed at an inner surface of a roof plate of the case and that is inserted into the hub and regulates a radial direction position of the reel; and
a protective protruding portion that is formed at the inner surface of the roof plate of the case,
wherein, when the reel slants with respect to the case, one end portion of the hub abuts against the protective protruding portion before the flange abuts against the inner surface of the roof plate so as to prevent the flange from abutting against the inner surface of the roof plate, and
wherein the protective protruding portion is formed such that a radial direction outer side end surface thereof is at substantially the same position in the radial direction as the outer periphery surface of the hub.

2. A recording tape cartridge comprising:
a reel including a substantially circular tubular hub, on an outer periphery surface of which a recording tape is wound, and flanges provided at two end portions of the hub;
a case accommodating the reel;
an urging portion that urges the reel toward a floor plate side of the case;
a position regulating portion that is formed at an inner surface of a roof plate of the case and that is inserted into the hub and regulates a radial direction position of the reel; and
a protective protruding portion that is formed at the inner surface of the roof plate of the case,
wherein, when the reel slants with respect to the case, one end portion of the hub abuts against the protective protruding portion before the flange abuts against the inner surface of the roof plate so as to prevent the flange from abutting against the inner surface of the roof plate, and
wherein the protective protruding portion is formed such that a radial direction outer side end surface thereof is at a position further to the radial direction inner side relative to the outer periphery surface of the hub.

3. The recording tape cartridge according to claim 1, wherein the protective protruding portion is structured with a plurality of ribs extending in a radial pattern.

4. The recording tape cartridge according to claim 2, wherein the protective protruding portion is structured with a plurality of ribs extending in a radial pattern.

5. The recording tape cartridge according to claim 1, wherein the case is formed with a resin material, and
wherein a suppressing portion that suppresses a tilt of the position regulating portion due to resin contraction at a time of molding, is formed at the inner surface of the roof plate of the case, at the radial direction inner side of the position regulating portion.

6. The recording tape cartridge according to claim 2, wherein the case is formed with a resin material, and
wherein a suppressing portion that suppresses a tilt of the position regulating portion due to resin contraction at a time of molding, is formed at the inner surface of the roof plate of the case, at the radial direction inner side of the position regulating portion.

7. The recording tape cartridge according to claim 1, wherein the inner surface of the roof plate of the case at the radial direction outer side relative to the protective protruding portion is formed in a substantial taper shape in cross-section such that a space inside the case widens towards the radial direction outer side.

8. The recording tape cartridge according to claim 2, wherein the inner surface of the roof plate of the case at the radial direction outer side relative to the protective protruding portion is formed in a substantial taper shape in cross-section such that a space inside the case widens towards the radial direction outer side.

9. The recording tape cartridge according to claim 1, wherein the position regulating portion has a structure in which a plurality of small ribs with substantial circular arc shapes in bottom view are provided projecting non-continuously.

10. The recording tape cartridge according to claim 2, wherein the position regulating portion has a structure in which a plurality of small ribs with substantial circular arc shapes in bottom view are provided projecting non-continuously.

11. The recording tape cartridge according to claim 1, wherein the protective protruding portion is structured in an annular shape, and the height thereof is constant in the radial direction.

12. The recording tape cartridge according to claim 2, wherein the protective protruding portion is structured in an annular shape, and the height thereof is constant in the radial direction.
